(19) United States
(12) Patent Application Publication
(10) Pub. No.: US 2009/0185529 A1
(43) Pub. Date: Jul. 23, 2009

(54) MOBILE COMMUNICATION SYSTEM, BASE STATION CONTROLLER, BASE STATION AND COMMUNICATION CONNECTION METHOD

(75) Inventors: Kiyotaka Tsuji, Tokyo (JP); Keiji Yamamoto, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/352,755

(22) Filed: Jan. 13, 2009

(30) Foreign Application Priority Data
Jan. 23, 2008 (JP) 2008-012821

(51) Int. Cl. H04W 72/04

(52) U.S. Cl. 370/329; 455/450

(57) ABSTRACT

A mobile communication system which can prevent deterioration of a utilization ratio of a radio channel and degradation of communication quality is provided. The mobile communication system has a mobile terminal, base station, and a base station controller. The mobile terminal issues a link channel establishment request in order to communicate with another mobile terminal. The base station receives the link channel establishment request, and outputs a radio channel assignment request. When the base station controller receives the radio channel assignment request, the base station controller assigns the base station a radio channel which is not used in the base station and its adjacent base station and outputs a radio channel assignment answer. When the base station receives the radio channel assignment answer, the base station returns a link channel assignment answer to the mobile terminal, and establishes a communication connection with the mobile terminal by an assigned radio channel.

### CROSS REFERENCE TO RELATED APPLICATION

This application is based upon and claims the benefit of priority from the Japanese Patent Application No. 2008-012821, filed on Jan. 23, 2008, the entire contents of which are incorporated herein by reference.

### FIELD OF THE INVENTION

The present invention relates to a mobile communication system which performs a communication connection of a mobile terminal which sent out a link channel establishment request, and a base station controller, a base station, and a communication connection method used for this system.

### DESCRIPTION OF THE BACKGROUND

Generally, a mobile communication system is provided with a mobile terminal for sending out a link channel establishment request for a communication connection, and a plurality of base stations for making a communication connection with this mobile terminal. A conventional base station is provided with a radio channel assignment unit. When the base station receives the link channel establishment request from the mobile terminal, the base station assigns a radio channel arbitrarily and makes the communication connection with the mobile terminal.

In the conventional mobile communication system, when the link channel establishment request is sent out to each base station which adjoins mutually from each mobile terminal belonging to each base station, there is a case where each adjoining base station assigns the same radio channel for a communication with each mobile terminal.

In this case, there is a possibility that a radio wave of one base station may interfere a mobile terminal which communicates with another base station. For this reason, this interference was dissolved by the change of a radio channel of one base station (see Japanese patent application publication No. 2000-102062, for example).

If interference occurs, it is necessary to change the radio channel each time. For this reason, such phenomena occur at a plurality of places caused deterioration of a utilization ratio of the radio channels, and degradation of communication quality.

As mentioned above, in the conventional mobile communication system, the same radio channel may be used by adjoining base stations. For interference control, a change of the radio channel under communication was obliged, and there was a problem that deterioration of a utilization ratio of the radio channels and degradation of communication quality arose.

### SUMMARY OF THE INVENTION

The present invention was made by the above-mentioned circumstance.

The purpose of the present invention is to provide a mobile communication system, a base station controller, a base station and a communication connection method which can prevent deterioration of a utilization ratio of radio channels and degradation of communication quality accompanying a change of the radio channel.

In order to attain the above-mentioned purpose, according to one aspect of the present invention, a mobile communication system having a mobile terminal, a plurality of base stations and a base station controller is provided. The mobile terminal sends out a link channel establishment request for radio communication. A plurality of base stations output a radio channel assignment request when a link channel establishment request is received, and makes a radio communication with the mobile terminal using a radio channel assigned by a radio channel assignment answer when the radio channel assignment answer is received. When a base station controller receives the radio channel assignment request, the base station controller assigns to the base station of a requiring origin an unused radio channel in the base station of a requiring origin and the base station adjacent to the base station of the requiring origin, and outputs the channel assignment answer to the base station of the requiring origin.

According to one aspect of the present invention, a base station controller used for a mobile communication system having a mobile terminal configured to send out a link channel establishment request for radio communication, and a plurality of base stations configured to output a radio channel assignment request and make the radio communication with the mobile terminal using an assigned radio channel when the plurality of base stations receive the link channel establishment request, is provided. The base station controller includes an adjacent base station information management unit which manages adjacent base station information which showing a positional relationship of the base stations and a status of use of a radio channel assigned to each the base station, a radio channel assignment control unit which discriminates the radio channel currently assigned to the base station of a requiring origin and the base station adjacent to the base station of the requiring origin, and determines an unused radio channel in the base station of the requiring origin and the base station adjacent to the base station of the requiring origin, and assigns the unused radio channel determined to the base station of the requiring origin if a radio channel assignment request is received.

According to one aspect of the present invention, it is provided a base station which is configured to output a radio channel assignment request for radio communication to a base station controller when a link channel establishment request for radio communication sent out from a mobile terminal is received, and to make the radio communication with the mobile terminal using an assigned radio channel when an unused radio channel in a base station of a requiring origin and a base station adjacent to the base station of the requiring origin is assigned by the base station controller.

According to one aspect of the present invention, it is provided a communication connection method which includes sending out a link channel establishment request for radio communication from a mobile terminal, outputting a radio channel assignment request to a base station controller from a base station which received the link channel establishment request, assigning said base station of requiring origin an unused radio channel in the base station of the requiring origin and a base station adjacent to the base station of the requiring origin by the base station controller which received the radio channel assignment request, and outputting a radio channel assignment answer including information on an assigned unused radio channel to the base station by the base station controller which received the radio channel assignment request.

### BRIEF DESCRIPTION OF THE DRAWINGS

FIG. 1 is a block diagram showing composition of one embodiment of a mobile communication system according to the present invention.

FIG. 2 is a block diagram schematically illustrating a configuration of a base station of the above mentioned embodiment.

FIG. 3 is a block diagram schematically illustrating a configuration of a base station controller of the above mentioned embodiment.

FIG. 4 is a block diagram showing a functional configuration of the base station controller of the above mentioned embodiment.

FIG. 5 is a sequence diagram showing radio channel assignment/release procedure of a mobile communication system of the above mentioned embodiment.

FIG. 6 is a block diagram schematically illustrating a configuration at the time of a link channel establishment request being sent out from two sets of mobile terminals in the mobile communication system of the above mentioned embodiment.

FIG. 7 is a sequence diagram showing a radio channel assignment procedure in FIG. 6.

### DETAILED DESCRIPTION OF THE INVENTION

Hereinafter, an embodiment of this invention will be explained in detail with reference to the drawings.

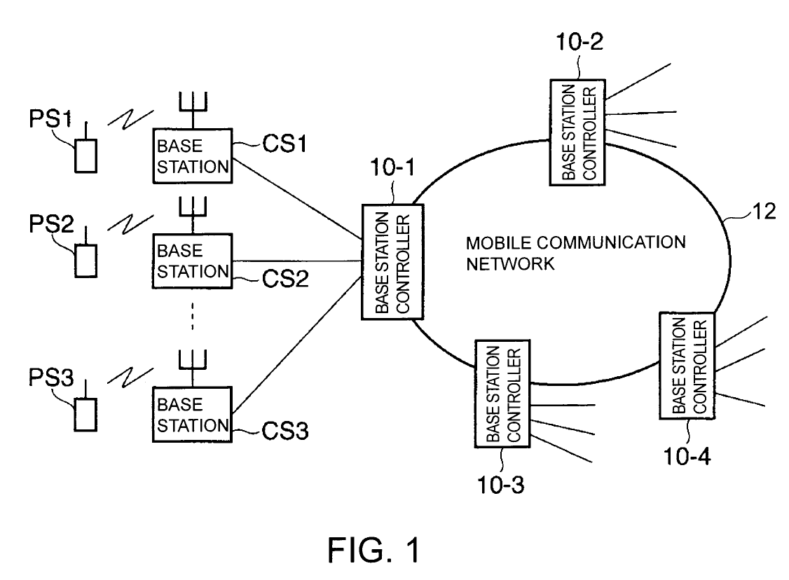

FIG. 1 is a block diagram schematically illustrating the configuration of a mobile communication system according to one embodiment of the present invention. FIG. 1 shows the mobile communication system whose communication method is PHS (Personal Handyphone System).

Base station controllers 10-1 to 10-4 are mutually connected through IP (Internet Protocol) network 12. Base station controller 10-1 to 10-4 and IP network 12 form a mobile communication network which exchanges control information, sounds and data mutually. Base station controller 10-1 accommodates mobile terminals PS1-PS3, such as a PHS terminal, and base stations CS1-CS3.

In this embodiment, base station controller 10-1 and base stations CS1-CS3 are connected by IP line. Base station controller 10-1 and base stations CS1-CS3 may be connected by a telephone line or an optical line. In this embodiment, a signal transmitted to base station controller 10-1 through the mobile communication network and a signal transmitted and received between base station controller 10-1 and base stations CS1-CS3 take a form of an IP packet.

In FIG. 1, mobile terminal PS1 sends out a link channel establishment request to base station CS1 at the time of communication connection establishment. When base station CS1 receives the link channel establishment request, base station CS1 outputs a radio channel assignment request to base station controller 10-1. When base station controller 10-1 receives the radio channel assignment request, base station controller 10-1 assigns base station CS1 an arbitrary radio channel which are not used in base station CS1 and an adjacent base station adjacent to base station CS1, and outputs radio channel assignment answer to base station CS1 of demand-origin. A radio channel assignment answer includes radio channel assignment information about the assigned radio channel. Base station CS1 which received the radio channel assignment answer returns a link channel assignment answer to mobile terminal PS1 of a requiring origin.

Here, a radio channel is used in a radio communication between the mobile terminal and the base station. In this embodiment, the radio channel is determined by a frequency and a time slot in one frame.

At the time of radio communication disconnection, mobile terminal PS1 issues a notice of disconnection to base station CS1. Base station CS1 which received the notice of disconnection outputs a radio channel disconnection request to base station controller 10-1. When base station controller 10-1 receives the radio channel disconnection request, base station controller 10-1 changes the radio channel assigned to base station CS1 to the unused, and returns a radio channel disconnection response to base station CS1. When base station CS1 receives the radio channel disconnection response, base station CS1 outputs a release notice to mobile terminal PS1.

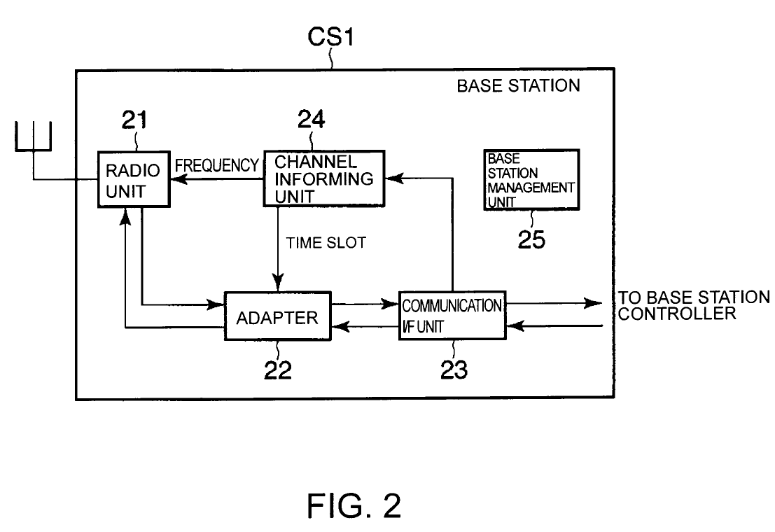

Next, a base station will be explained. FIG. 2 is a block diagram schematically illustrating a configuration of base station CS1 according to the one embodiment of the present invention. Mobile terminal PS1 sends out the link channel establishment request by radio frames, such as the FEC (Forward Error Correction) frame, at a time of requesting the a radio communication connection. In FIG. 2, base station CS1 receives this link channel establishment request by radio unit 21 and changes the link channel establishment request into a packet by adapter 22. Then, base station CS1 encapsulates the link channel establishment request into an IP packet by communication connection I/F unit 23 and transmits the link channel establishment request to base station controller 10-1.

When base station CS1 receives a radio channel assignment answer of IP packet form from base station controller 10-1, base station CS1 decapsulates the radio channel assignment answer by communication I/F unit 23 and changes the radio channel assignment answer into the radio frame by adapter 22. Then, base station CS1 outputs the radio channel assignment answer to mobile terminal PS1 from radio unit 21 as the link channel assignment answer.

At this time, radio channel assignment information included in the radio channel assignment answer is inputted also into channel informing unit 24 from communication I/F unit 23. Channel informing unit 24 discriminates the frequency and the time slot in one frame assigned to the radio communication of mobile terminal PS1 from radio channel assignment information. Channel informing unit 24 notifies the assigned time slot to adapter 22 and notifies the assigned frequency to radio unit 21.

In base station CS1, when communication I/F unit 23 receives a sound and data from base station controller 10-1 while base station CS1 and mobile terminal PS1 communicate, communication I/F unit 23 decapsulates the sound and the data to a RTP (Real-time Transport Protocol) packet and sends the RTP packet to adapter 22. When adapter 22 receives the RTP packet, adapter 22 puts this packet on the radio frame, inserts the radio frame in the assigned time slot notified from channel informing unit 24, and outputs the radio frame to radio unit 21. Radio unit 21 sends out the radio frame from adapter 22 to mobile terminal PS1 with the frequency notified from channel informing unit 24.

Base station CS1 receives the sound and the data transmitted from mobile terminal PS1 on the assigned frequency and the assigned time slot as the communication channel with radio unit 21, and base station CS1 takes the RTP packet of the sound and the data out from the radio frame with adapter 22. Then, base station CS1 encapsulates the RTP packet to an IP packet with communication I/F unit 23 and transmits the IP packet to base station controller 10-1.

Furthermore, base station CS1 is provided with base station management unit 25. This base station management unit 25 supervises abnormalities in components of base station CS1. When base station management unit 25 detects that an abnormality occurred, base station management unit 25 notifies the occurrence of the abnormality to base station controller 10-1. When base station management unit 25 detects the occurrence of the abnormality, base station CS1 does not receive the link channel establishment request from the mobile terminal.

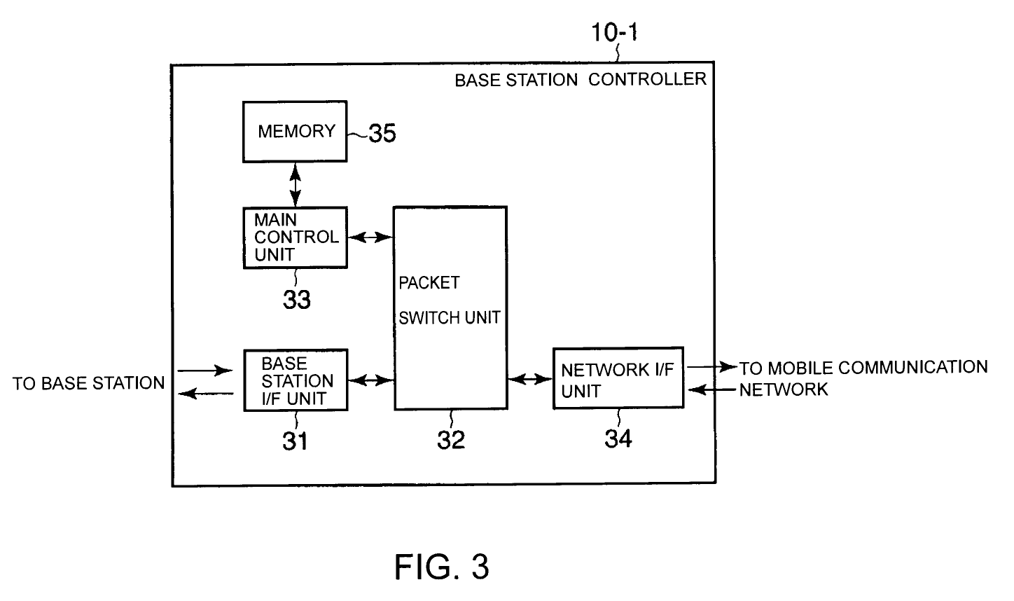

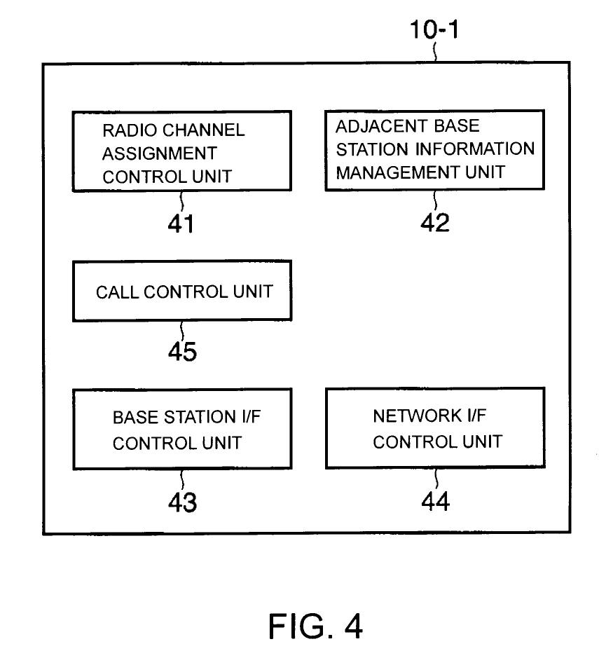

Next, the base station controller will be explained. FIG. 3 is a block diagram schematically illustrating a configuration of base station controller 10-1 according to the one embodiment of the present invention. And FIG. 4 is a block diagram showing a functional configuration of base station controller 10-1.

In FIG. 3, base station controller 10-1 is connected with base station CS1 via base station I/F unit 31. When base station controller 10-1 receives the radio channel assignment request from base station CS1 with base station I/F unit 31, base station controller 10-1 outputs the radio channel assignment request to plural lines selectively with packet switch unit 32. Specifically, packet switch unit 32 discriminates an address of the packet from contents of a header of the IP packet inputted and switches an output destination of the packet to main control unit 33 or network I/F unit 34 alternatively based on the address. In FIG. 4, base station controller 10-1 is provided with radio channel assignment control unit 41, adjacent base station information management unit 42, base station I/F control unit 43, network I/F control unit 44 and call control unit 45 as the functional configuration.

Main control unit 33 is provided with radio channel assignment control unit 41 shown in FIG. 4. When main control unit 33 receives the radio channel assignment request outputted from packet switch unit 32, main control unit 33 determines the radio channel which should be assigned to base station CS1 with reference to adjacent base station information currently recorded on memory 35 mentioned later.

Main control unit 33 and memory 34 are provided with the adjacent base station information management unit 42 shown in FIG. 4, and manages adjacent base station information. In this embodiment, the adjacent base station information contains a positional relationship of base stations CS1-CS3 and the status of use of radio channels currently assigned to base stations CS1-CS3. The positional relationship of base stations CS1-CS3 is beforehand recorded on memory 35 as an information table based on a handover history of mobile terminals PS1-PS3. The status of use of the radio channels is also recorded on memory 35 as the information table. These information tables are updated whenever base station controller 10-1 assigns the radio channel to base stations CS1-CS3 and whenever mobile terminal PS1 disconnects the radio channel in a radio communication state.

Main control unit 33 discriminates the base station adjacent to base station CS1 from the positional relationship of base stations CS1-CS3 recorded on memory 35.

Main control unit 33 searches an unused radio channel from the status of use of the radio channels in base station CS1 and an adjacent base station of base station CS1, and assigns the arbitrary unused radio channel selectively to base station CS1.

Main control unit 33 is provided with base station I/F control unit 43 and network I/F control unit 44 shown in FIG. 4. Base station I/F control unit 43 makes base station I/F unit 31 perform transmission and reception of a signal to and from base stations CS1-CS3. And network I/F control unit 44 makes network I/F unit 34 perform transmission and reception of a signal via the mobile communication network. While base station controller 10-1 communicates with the mobile communication network, main control unit 33 transmits and receives the sound and the data with network I/F unit 34, and transmits and receives a signal to and from base station CS1 with base station I/F unit 31.

Main control unit 33 is provided with call control unit 45 shown in FIG. 4.

This call control unit 45 establishes a communication line between mobile terminal PS1 and base station CS1. Then, call control unit 45 performs a call control to another mobile terminal based on a specification of a communication party by mobile terminal PS1.

When main control unit 33 receives a notice of occurrence of abnormality from base station CS1, main control unit 33 shall not assign the radio channel to base station CS1 concerned.

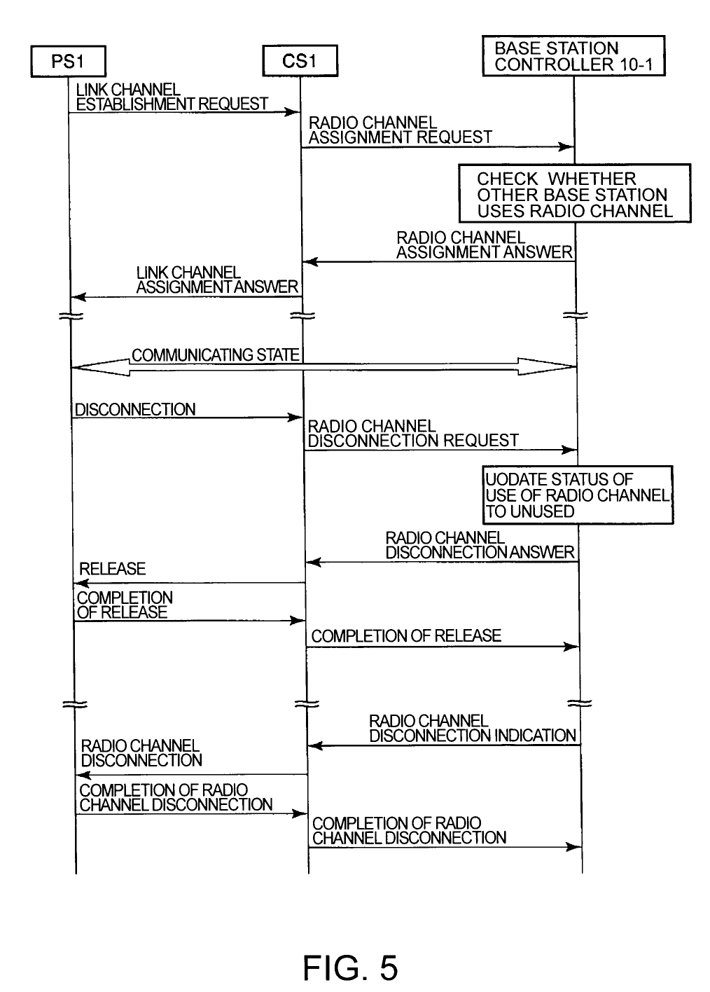

Next, radio channel assignment/release of the mobile communication system will be explained. FIG. 5 is a sequence diagram showing a procedure of radio channel assignment/release of the mobile communication system according to the one embodiment of the present invention.

First, the radio channel assignment will be explained. Mobile terminal PS1 issues the link channel establishment request to base station CS1. Base station CS1 which received this issues the radio channel assignment request to base station controller 10-1. Base station controller 10-1 which received the radio channel assignment request searches availability of the radio channel in base station CS1 and an adjacent base station of base station CS1, with reference to the adjacent base station information created beforehand in memory 35. And base station controller 10-1 assigns an unused radio channel to base station CS1, and base station controller 10-1 returns the radio channel assignment answer including the information about the assigned radio channel to base station CS1. At this time, base station controller 10-1 registers “under use” about the assigned radio channel to the information table of memory 35. Base station CS1 which received the radio channel assignment answer sends out the link channel assignment answer to mobile terminal PS1.

After this, a communication connection between the mobile terminals becomes possible by passing through a conventional sequence.

Next, the radio channel release will be explained. First, a case where mobile terminal PS1 disconnects a telephone call will be explained. Release of the radio channel begins from issue of a notice of disconnection of mobile terminal PS1. When base station CS1 receives the notice of disconnection, base station CS1 issues a radio channel disconnection request to base station controller 10-1. When base station controller 10-1 receives the radio channel disconnection request, base station controller 10-1 updates the information table of memory 35 about the radio channel of which the radio channel disconnection request is requested “unused”, and returns a radio channel disconnection answer to base station CS1. When base station CS1 receives the radio channel disconnection answer, base station CS1 issues a notice of release to mobile terminal PS1. In response to this, mobile terminal PS1 returns a release completion notification to base station CS1, and also base station CS1 transmits the completion of release to base station controller 10-1.

A case where a call party disconnects a telephone call will be explained.

Base station controller 10-1 sends out a radio channel disconnect indication to base station CS1, and, in response to this, base station CS1 issues the radio channel disconnect indication to mobile terminal PS1. When mobile terminal PS1 receives the radio channel disconnect indication, mobile terminal PS1 issues a notice of radio channel disconnection completion.
The notice of radio channel disconnection completion is transmitted to the base station controller 10-1 via base station CS1, and a release sequence is completed.

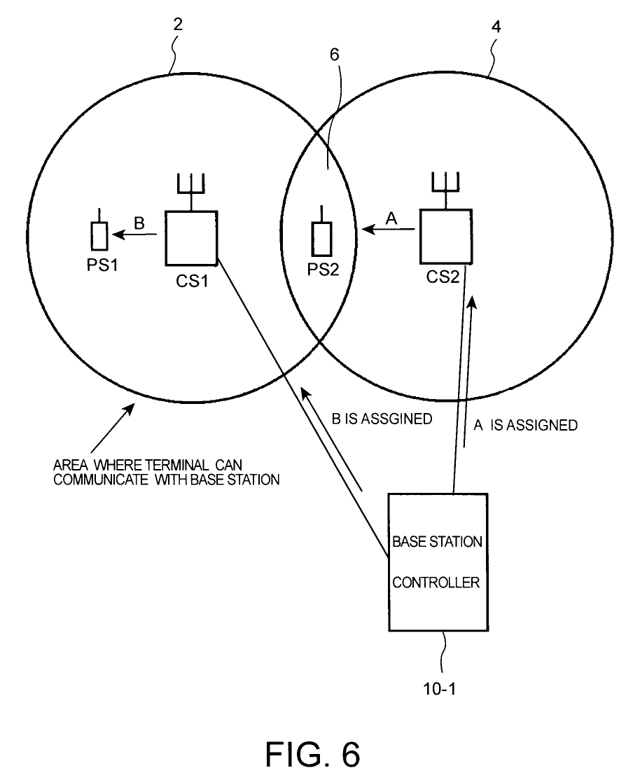

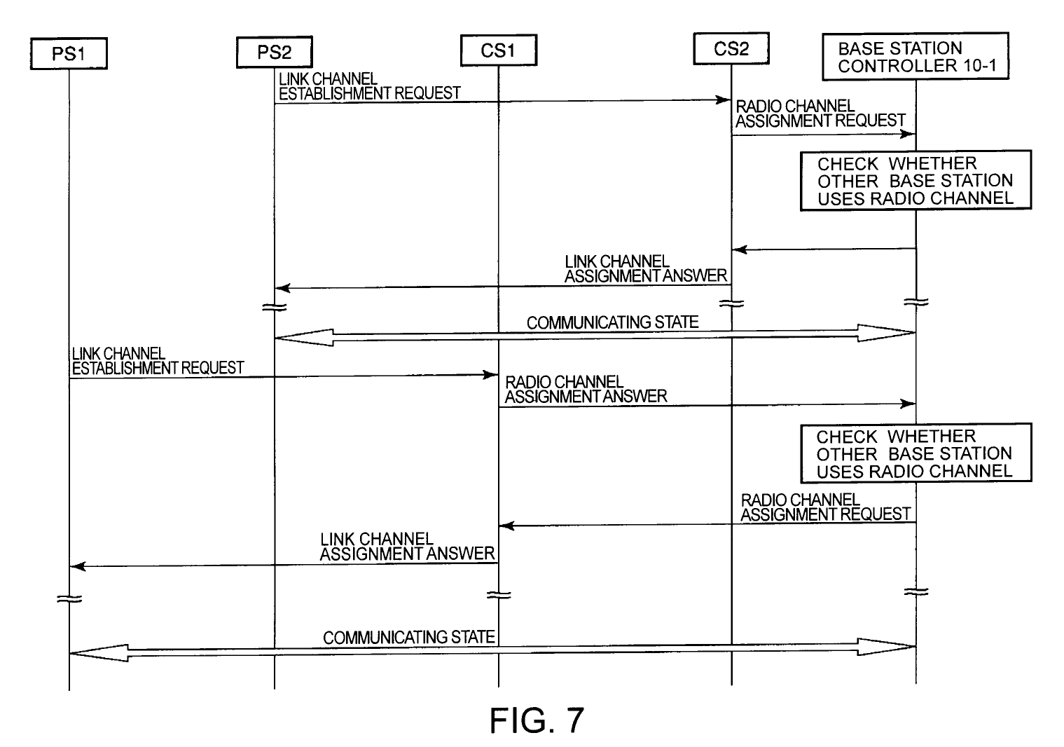

Next, a case where the link channel establishment requests are sent out from two sets of mobile terminals will be explained. FIG. 6 is a block diagram schematically illustrating a configuration in the case link channel establishment requests are sent out from two sets of mobile terminals in the mobile communication system according to the one embodiment of the present invention. FIG. 7 is a sequence diagram showing the radio channel assignment procedure in FIG. 6.

In FIG. 6, base stations CS1 and CS2 adjoin mutually, each area 2, 4 where the mobile terminal can communicate with the base station overlaps in some portions, and interference area 6 is formed. Mobile terminal PS1 sends out the link channel establishment request to base station CS1, and mobile terminal PS2 in interference area 6 sends out the link channel establishment request to base station CS2.

Mobile terminal PS2 follows the same sequence as the sequence shown in FIG. 5 and becomes possible to communicate with base station CS2 using radio channel A.

Here, when mobile terminal PS1 sends out the link channel establishment request, base station CS1 which received the link channel establishment request sends out the radio channel assignment request to base station controller 10-1. Base station controller 10-1 searches the radio channel. Since radio channel A is already assigned to adjoining base station CS2, base station controller 10-1 determines to assign unused radio channel B to base station CS1 and sends out the radio channel assignment answer including the information about an assigned radio channel to base station CS1. Base station CS1 which received the radio channel assignment answer returns the link channel assignment answer to mobile terminal PS1.

A radio channel assignment procedure will be explained with reference to FIG. 7. First, mobile terminal PS2 issues the link channel establishment request to base station CS2. Base station CS2 which received the link channel establishment request issues the radio channel assignment request to base station controller 10-1. Base station controller 10-1 which received the radio channel assignment request searches availability of the radio channel in base station CS2 and its adjacent base station with reference to the adjacent base station information created beforehand in memory 35. And base station controller 10-1 assigns unused radio channel A to base station CS2 and returns the radio channel assignment answer to base station CS2. At this time, base station controller 10-1 registers “under use” about assigned radio channel A on the information table of memory 35. Base station CS2 which received the radio channel assignment answer sends out the link channel assignment answer to mobile terminal PS2. After this, the communication connection between mobile terminal PS2 and another mobile terminal becomes possible by passing through the conventional sequence.

Furthermore, mobile terminal PS1 issues the link channel establishment request to base station CS1 while mobile terminal PS2 communicates with base station CS2 using radio channel A. Base station CS1 which received the link channel establishment request issues the radio channel assignment request to base station controller 10-1. Base station controller 10-1 which received the radio channel assignment request searches availability of the radio channel in base station CS1 and its adjacent base station with reference to the adjacent base station information created beforehand in memory 35.

And base station controller 10-1 assigns unused radio channel B to base station CS1, and returns the radio channel assignment answer to base station CS1. At this time, since radio channel A is “under use” in adjacent base station CS2, base station controller 10-1 does not choose radio channel A. Furthermore base station controller 10-1 registers “under use” about assigned radio channel B on the information table of memory 35. Base station CS1 which received the radio channel assignment answer sends out the link channel assignment answer to mobile terminal PS1. After this, the communication connection between mobile terminal PS1 and another mobile terminal becomes possible by passing through the conventional sequence.

As mentioned above, in the above-mentioned one embodiment, when base station CS1 receives the link channel establishment request from the mobile terminal, base station CS1 sends out the radio channel assignment request to base station controller 10-1.

Base station controller 10-1 which received the radio channel assignment request assigns the unused radio channel in base station CS1 and the adjacent base station of base station CS1 as the radio channel of base station CS1, and sends out the radio channel assignment answer to base station CS1. Thereby, since assigning the radio channel independently for every base station does not occur, using the same radio channel in adjacent base stations is avoided. For this reason, according to the embodiment, since the radio channel can be assigned so that the interference between adjacent base stations may not occur, it becomes possible to prevent the occurrence of the change of the radio channel.

As mentioned above, according to the present invention, since use of the same radio channel in adjacent base stations is avoided, the mobile communication system, the base station controller, the base station and the communication connection method which can prevent deterioration of the utilization ratio of the radio channel and degradation of the communication quality accompanying the change of the radio channel, can be provided.

Although this embodiment explains the case where the mobile terminal is a PHS terminal, the present invention is feasible similarly even if the mobile terminal is a cellular phone.

In this embodiment, although the case where the IP packet was used for transmission and reception of the signal between the base station and the base station controller was explained, the present invention is not necessarily restricted to the protocol of this IP packet.

Other embodiments or modifications of the present invention will be apparent to those skilled in the art from consideration of the specification and practice of the invention disclosed herein. It is intended that the specification and example embodiments be considered as exemplary only, with a true scope and spirit of the invention being indicated by the following.

What is claimed is:

1. A mobile communication system, comprising:
a mobile terminal configured to send out a link channel establishment request for radio communication;
a plurality of base stations configured to send out a radio channel assignment request when said link channel establishment request was received, and send out a link channel assignment answer when a radio channel assignment answer was received, and perform radio communication with said mobile terminal using a radio channel assigned by said radio channel assignment answer; and
a base station controller configured to assign said base station of a demand origin an unused radio channel in said base station of said demand origin and said base station adjacent to said base station of said demand origin, and send out said channel assignment answer to said base station of said demand origin.

2. The mobile communication system according to claim 1, wherein said base station controller has:
an adjacent base station information management unit which manages adjacent base station information which shows a positional relationship of said plurality of base stations and a status of use of a channel currently assigned to each of said base stations, and
a radio channel assignment control unit discriminates said radio channel currently assigned to said base station of said demand origin and said base station adjacent to said base station of said demand origin, and assigns said base station of said demand origin an unused radio channel in said base station of said demand origin and said adjacent base station of said base station of said demand origin, with reference to said adjacent base station information when said radio channel assignment request is received.

3. The mobile communication system according to claim 2, wherein
said mobile terminal sends out a notice of disconnection to said base station in a radio communication state when said mobile terminal disconnects said radio communication,
said base station sends out a disconnection request of assigned said radio channel to said base station controller, when said base station receives said notice of disconnection, and
said radio channel assignment control unit updates said adjacent base station information about said radio channel on which a disconnection is requested to unused, and sends out a disconnection answer to said base station of said disconnection requesting origin when said radio channel assignment control unit receives said disconnection request.

4. The mobile communication system according to claim 1, wherein a signal of IP (Internet Protocol) packet form is exchanged between said base station and said base station controller.

5. The mobile communication system according to claim 4, wherein
a system of said radio communication is PHS (Personal Handyphone System), and
said base station receives radio channel assignment information included in said radio channel assignment answer from said base station controller, and makes a connection with said mobile terminal by said PHS by using a frequency and a time slot in one frame specified with said radio channel assignment information as a communication channel.

6. A base station controller used for a mobile communication system having a mobile terminal which sends out a link channel establishment request for radio communication and a plurality of base stations which output a radio channel assignment request and perform radio communication with said mobile terminal using an assigned radio channel, when said base station receives said link channel establishment request, the base station controller comprising:
an adjacent base station information management unit for managing adjacent base station information showing a positional relationship of said plurality of base stations and a status of use of a channel currently assigned to each of said base stations; and
a radio channel assignment control unit configured to discriminate said radio channel currently assigned to said base station of said demand origin and said base station adjacent to said base station of said demand origin and, and determine an unused radio channel in said base station of said demand origin and said base station adjacent to said base station of said demand origin, with reference to said adjacent base station information when said radio channel assignment control unit receives said radio channel assignment request.

7. The base station controller according to claim 6, wherein
when said mobile terminal sends out a notice of disconnection to said base station which is in a radio communication state, and said base station receives said notice of disconnection and outputs a disconnection request of said assigned radio channel to said base station controller,
said radio channel assignment control unit update said adjacent base station information about said radio channel on which said disconnection request is requested to unused, and outputs a disconnection answer to said base station of said disconnection requesting origin when said radio channel assignment control unit receives said disconnection request.

8. The mobile communication system according to claim 6, wherein a signal of IP (Internet Protocol) packet form is exchanged between said base station and said base station controller.

9. A base station configured to output a radio channel assignment request configured to perform radio communication to a base station controller, when a link channel establishment request for radio communication sent out from a mobile terminal is received, and communicate with said mobile terminal using an assigned radio channel when an unused radio channel in a base station of demand origin and said base station adjacent to said base station of said demand origin is assigned by said base station controller.

10. The base station according to claim 9, wherein said base station is further configured to
output a notice of disconnection of said radio channel assigned to said base station controller when a notice of disconnection of said radio communication is received from said mobile terminal in a radio communication state, and
send a release notice of said communicating state to said mobile terminal when a disconnection response to said disconnection request concerned is received from said base station controller.

11. The mobile communication system according to claim 9, wherein a signal of IP (Internet Protocol) packet form is exchanged between said base station and said base station controller.

12. The base station according to claim 9, wherein
when a system of said radio communication is PHS (Personal Handyphone System),
said base station receives radio channel assignment information included in said radio channel assignment answer from said base station controller, and connects with said mobile terminal by said PHS by using a frequency and a time slot in one frame specified by said radio channel assignment information as a communication channel.

13. A communication connection method comprising:
sending out a link channel establishment request for radio communication from a mobile terminal,
outputting a radio channel assignment request to a base station controller from a base station which received said link channel establishment request,
assigning said base station of said demand origin an unused radio channel in said base station of said demand origin and a base station adjacent to said base station of said demand origin, by said base station controller which received said radio channel assignment request; and
outputting a radio channel assignment answer including information on said unused radio channel assigned to said base station by said base station controller which received said radio channel assignment request.

14. The communication connection method according to claim 13, wherein
outputting a link channel assignment answer to said mobile terminal which sent out said link channel establishment request from said base station which received said channel assignment answer, and
said mobile terminal communicating with said base station using said radio channel specified with said link channel assignment answer.
